(19) United States
(12) Patent Application Publication
(10) Pub. No.: US 2021/0042534 A1
(43) Pub. Date: Feb. 11, 2021

(54) VEHICLE OPERATION SYSTEM

(71) Applicant: TOYOTA JIDOSHA KABUSHIKI KAISHA, Toyota-shi (JP)

(72) Inventors: Miyako HAYASHIDA, Miyoshi-shi (JP); Toshinari OGAWA, Nagoya-shi (JP); Kosuke FUJIMOTO, Nisshin-shi (JP); Hideo HASEGAWA, Nagoya-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 16/917,092

(22) Filed: Jun. 30, 2020

(30) Foreign Application Priority Data
Aug. 9, 2019 (JP) 2019-147843

(51) Int. Cl. G06K 9/00; G06T 7/207; B60W 50/14

(52) U.S. Cl. CPC G06K 9/00791; B60W 2050/146; B60W 50/14; G06T 7/207

(57) ABSTRACT

A vehicle operation system, comprising: an imaging device configured to capture video footage of conditions peripheral to a vehicle; a display device; a memory; and a processor that is coupled to the memory, the processor being configured to: allow the vehicle to be driven by remote operation by an operator; acquire video footage captured by the imaging device and perform image processing on the captured video footage to thereby generate processed video footage; display the processed video footage to the operator at the display device; and change image qualities of the captured video footage and the processed video footage in accordance with predetermined status information.

### CROSS-REFERENCE TO RELATED APPLICATION

This application claims priority under 35 USC 119 from Japanese Patent Application No. 2019-147843, filed on Aug. 9, 2019, the disclosure of which is incorporated by reference herein in its entirety.

### BACKGROUND

### Technical Field

The present disclosure relates to a vehicle operation system,

### Related Art

Japanese Patent Application Laid-open (JP-A) No. 2013-252854 discloses a vehicle equipped with autopilot means. When exiting its garage, the vehicle equipped with the autopilot means grasps conditions of obstacles around the vehicle and automatically moves to a place where there is sufficient space for an occupant to get into and out of the vehicle.

In this connection, advanced control technologies are needed to perform self-driving of vehicles, so in recent years remote operation technologies that can render unnecessary operation of the vehicle by an occupant with a relatively simple configuration have been developed. Examples of such remote operation technologies include a remote operation system where a display device located in a remote location receives video data of the area around a vehicle that the vehicle has acquired and where an operator, while watching the video data, remotely operates the vehicle to move it to the place of a person waiting for dispatch of the vehicle. However, depending on the data amount of the video data that the operator watches and the load on the network, for example, it takes time to process, transmit, and receive the video, and there is the potential for a delay to occur between the actual driving state of the vehicle and the video data. If the data amount is reduced to avoid this, there is the potential for the quality of the video presented to the operator to be reduced, resulting in a reduction in operability during remote operation, and in these respects there is room for improvement.

### SUMMARY

The present disclosure obtains a vehicle operation system that can smoothly perform remote operation of a vehicle.

A first aspect of the disclosure is a vehicle operation system, comprising: an imaging device configured to capture video footage of conditions peripheral to a vehicle; a display device; a memory; and a processor that is coupled to the memory, the processor being configured to: allow the vehicle to be driven by remote operation by an operator; acquire video footage captured by the imaging device and perform image processing on the captured video footage to thereby generate processed video footage; display the processed video footage to the operator at the display device; and change image qualities of the captured video footage and the processed video footage in accordance with predetermined status information.

According to the first aspect, the vehicle operation system has an imaging device, a display device, a memory and a processor that is coupled to the memory. The imaging device captures video footage of conditions peripheral to the vehicle. The processor allows the vehicle to be driven by remote operation by the operator. Furthermore, the processor acquires captured video footage that the imaging device has captured and performs image processing on the captured video footage to thereby generate processed video footage. Moreover, the processor displays to the operator the processed video footage at the display device. Furthermore, the processor changes, in accordance with predetermined status information, the image qualities of the captured video footage and the processed video footage. Consequently, by changing the image qualities in accordance with the state of communication and the state of image processing, delays when displaying the video footage can be inhibited so that a reduction in operability during remote operation can be inhibited.

Here, “image quality” means at least one of the resolution, frame rate, or bit rate of the video footage.

A second aspect of the disclosure is the vehicle operation system of the first aspect, wherein the processor is configured to set an image quality of the captured video footage to be lower than a standard image quality.

According to the second aspect, even in a case where the processing load of the processor has become high and/or a case where the load on the network when transmitting the captured video footage from the imaging device to the processor has become high, a delay in processing can be inhibited because the data amount of the captured video footage is reduced by lowering the image quality below what it is standard.

A third aspect of the disclosure is the vehicle operation system of the first or second aspect, wherein the processor is configured to set an image quality of the processed video footage to be lower than a standard image quality.

According to the third aspect, the processor is configured to set the image quality of the processed video footage to be lower than the standard image quality, so even in a case where the load on the network when transmitting the processed video footage from the processor to the display device has become high, a delay when displaying the processed video footage to the operator can be inhibited because the data amount of the processed video footage is reduced by lowering the image quality below what it is standard.

A fourth aspect of the disclosure is the vehicle operation system of the third aspect, wherein the processor generates the processed video footage by applying an emphasis display that emphasizes an object of attention in the captured video footage.

According to the fourth aspect, the processor generates the processed video footage by applying the emphasis display that emphasizes the object of attention in the captured video footage, so it becomes easier for the operator to grasp the object of attention even in a state in which the image quality of the processed video footage has been reduced below the standard image quality.

As described above, the vehicle operation system pertaining to the first aspect can smoothly perform remote operation of the vehicle.

The vehicle operation system pertaining to the second aspect can smoothly perform remote operation of the vehicle in a case where the load on the communication network from the vehicle to the server is high and/or a case where the processing load of the server itself is high.

The vehicle operation system pertaining to the third aspect can smoothly perform remote operation of the vehicle in a case where the load on the communication network from the server to the operator is high.

The vehicle operation system pertaining to the fourth aspect can perform remote operation of the vehicle safely and smoothly even in a case where the image quality of the processed video footage is low.

### BRIEF DESCRIPTION OF THE DRAWINGS

An exemplary embodiment of the disclosure will be described in detail based on the following figures, wherein:

FIG. 1 is an overview drawing showing an overview of a vehicle operation system pertaining to the embodiment;

FIG. 2 is an overview drawing showing remote operation by the vehicle operation system pertaining to the embodiment;

FIG. 3 is a block diagram showing the hardware configuration of a vehicle of the vehicle operation system pertaining to the embodiment;

FIG. 4 is a block diagram showing the hardware configuration of a control center of the vehicle operation system pertaining to the embodiment;

FIG. 5 is a block diagram showing the hardware configuration of a server of the vehicle operation system pertaining to the embodiment;

FIG. 6 is a block diagram showing the hardware configuration of a user terminal of the vehicle operation system pertaining to the embodiment;

FIG. 7 is a block diagram showing functional configurations of the vehicle operation system pertaining to the embodiment; and

FIG. 8 is a flowchart showing a flow of actions by the vehicle operation system pertaining to the embodiment.

### DETAILED DESCRIPTION

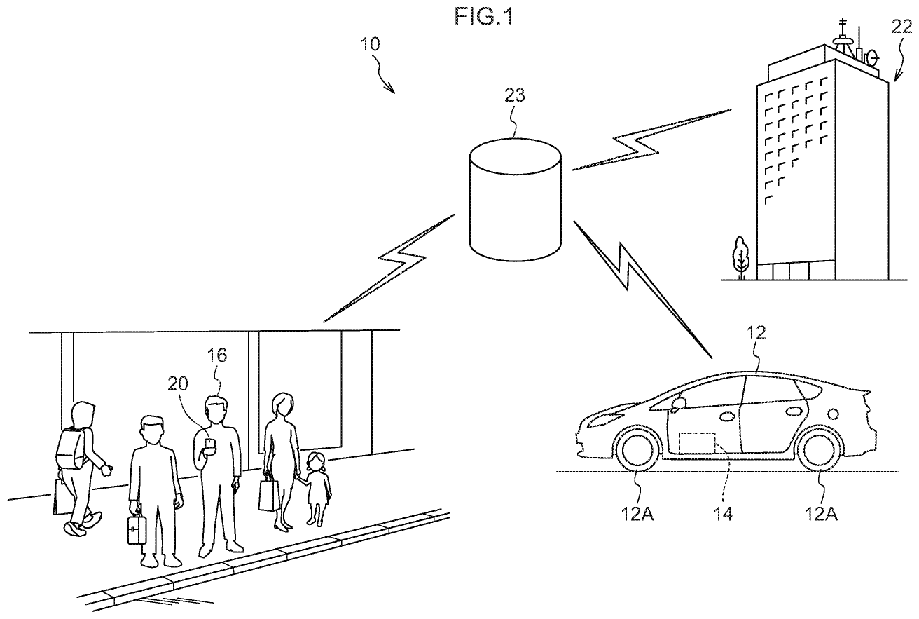

An embodiment of a vehicle operation system 10 pertaining to the disclosure will be described below using FIG. 1 to FIG. 8.

(Overall Configuration)

FIG. 1 is a drawing showing the general configuration of the vehicle operation system 10 pertaining to the embodiment.

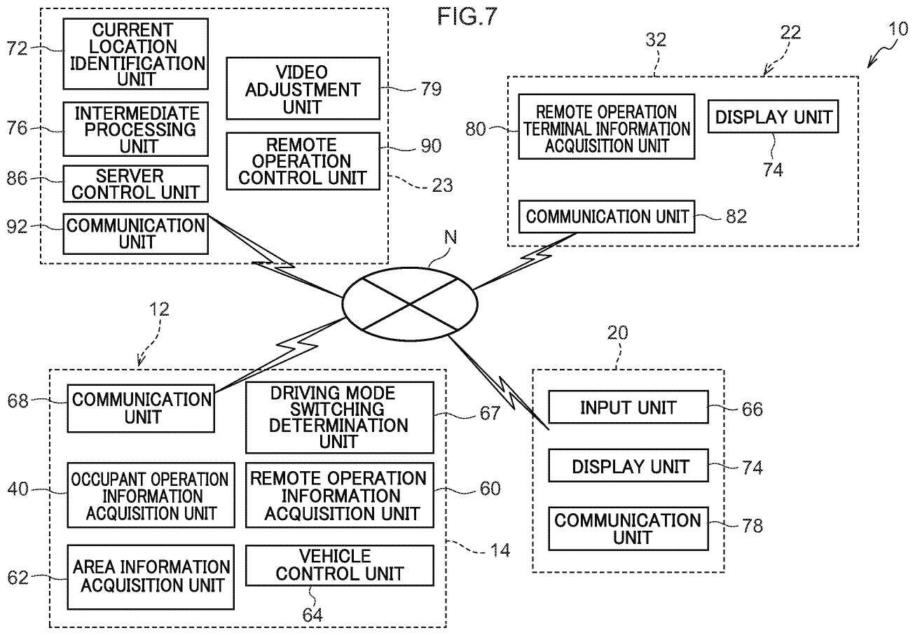

As shown in FIG. 1, the vehicle operation system 10 is configured to include an on-board unit 14 installed in a vehicle 12, a user terminal 20, a control center 22, and a server 23. The on-board unit 14, the control center 22, the user terminal 20, and the server 23 are communicably connected via a network N (see FIG. 7). For the network N, the Internet or a wide area network (WAN), for example, is applied.

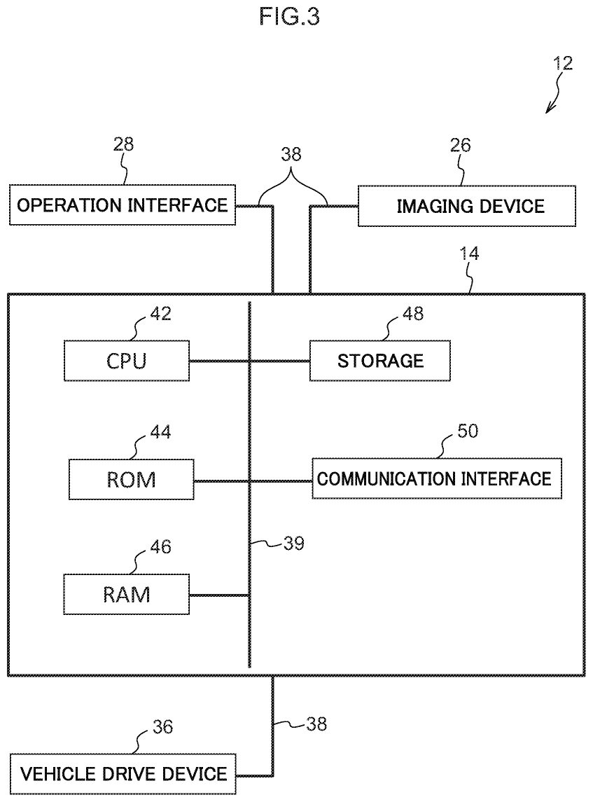

The vehicle 12 is, for example, a typical passenger car and can be manually driven by means of an operation interface 28 (see FIG. 3) inside the vehicle and remotely operated from the control center 22 utilizing video footage from an imaging device 26 (see FIG. 3). Furthermore, the on-board unit 14 can transmit usage conditions and the vehicle state of the vehicle 12 to the server 23 provided outside the vehicle. The specific configuration and action of the on-hoard unit 14 will be described later.

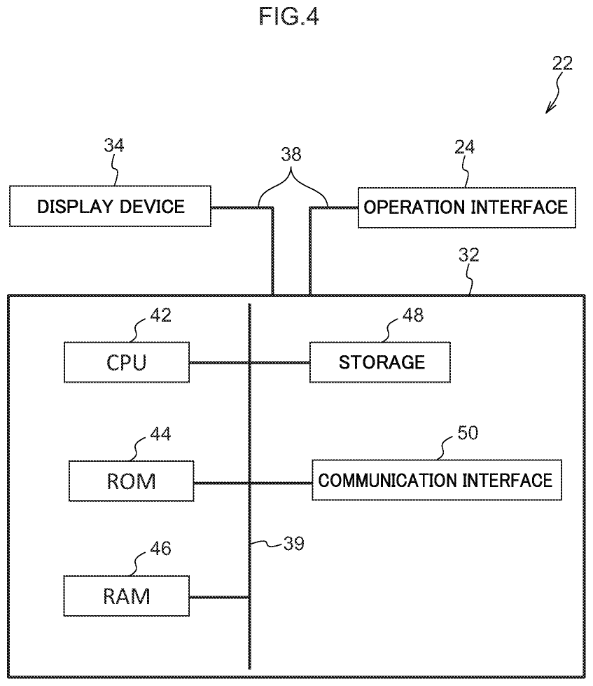

The control center 22 is provided with an operation interface 24 for remotely operating the vehicle 12, a remote operation terminal information acquisition device 32, a display device 34 (see FIG. 4), and the server 23 (in FIG. 1, the server 23 and the control center 22 are shown separate to facilitate understanding of the main configuration). The server 23 collects various types of information from the on-board unit 14 and the remote operation terminal information acquisition device 32 and manages as a database the information it has collected, and also transmits various types of information. The specific configurations and actions of the operation interface 24, the remote operation terminal information acquisition device 32, the display device 34, and the server 23 will be described later.

The user terminal 20 is, for example, a smartphone, a cellphone, a tablet computer, a personal computer, or a game terminal, and is carried by a user 16. The specific configuration and action of the user terminal 20 will be described ate

(Hardware Configurations)

As shown in FIG. 3, the vehicle 12 has the operation interface 28, the imaging device 26, the on-hoard unit 14, and a vehicle drive device 36. These configurations are communicably connected to each other via a bus 38.

The operation interface 28 is disposed on the vehicle front side of the cabin of the vehicle 12 and is configured to include a steering wheel, an accelerator pedal, a brake pedal, and a gear shaft lever (none of which are shown in the drawings). The operation interface 28 is connected to a later-described occupant operation information acquisition unit 40 (see FIG. 7) of the on-board unit 14.

The imaging device 26 is, for example, provided inside the cabin of the vehicle 12 and captures video footage of conditions outside the vehicle 12 mainly in the forward direction of the vehicle 12. The captured video footage is sent to the on-board unit 14.

The on-board unit 14 is configured to include a central processing unit (CPU) 42, read-only memory (ROM) 44, a random-access memory (RAM) 46, a storage 48, and a communication interface 50. These configurations are communicably connected to each other via a bus 39.

The CPU 42 executes various types of programs and controls each part. That is, the CPU 42 reads programs from the ROM 44 or the storage 48 and executes the programs using the RAM 46 as a work area. The CPU 42 controls each of the above configurations and performs various types of processing in accordance with the programs recorded in the ROM 44 or the storage 48. In this embodiment, a vehicle operation program is stored in the ROM 44 or the storage 48.

The ROM 44 stores various types of programs and various types of data. The RAM 46 temporarily stores the programs or data as a work area. The storage 18 is configured by a hard disk drive (HDD) or a solid-state drive (SSD) and stores various types of programs, including an operating system, and various types of data.

The communication interface 50 is an interface for the on-board unit 14 to communicate with the server 23 and uses a standard such as Ethernet (registered trademark), FDDI, or Wi-Fi (registered trademark), for example.

The vehicle drive device 36 activates an engine (not shown in the drawings) that drives wheels 12A (see FIG. 1) of the vehicle 12 on the basis of control by the on-board unit 14.

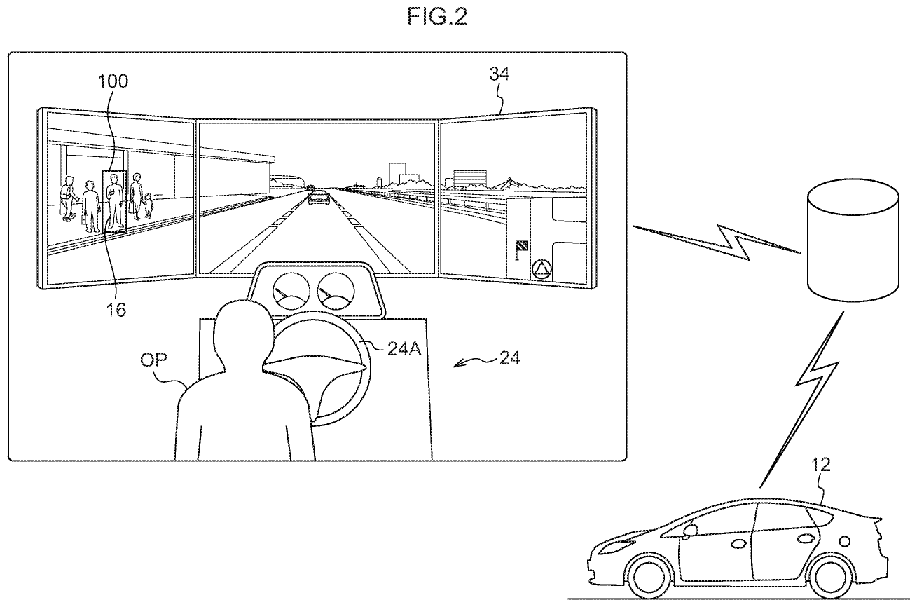

As shown in FIG. 4, the operation interface 24, the display device 34, and the remote operation terminal information acquisition device 32 of the control center 22 are communicably connected to each other via a bus 38. The operation interface 24 is, for example, configured from a remote control steering wheel 24A (see FIG. 2), a remote control accelerator pedal, a remote control brake pedal, and a remote control gear shift lever (none of which are shown in the drawings), and is provided in order for an operator OP (see FIG. 2) inside the control center 22 to perform remote operation of the vehicle 12. The operation interface 24 is, for example, allocated to the operator OP standing by inside the control center 22. It will be noted that the operation interface 24 may also be configured to include a keyboard, a mouse, and a joystick (none of which are shown in the drawings).

The remote operation terminal information acquisition device 32 is configured to include a CPU 42, a ROM 44, a RAM 46, a storage 48, and a communication interface 50. These configurations are communicably connected to each other via a bus 39. The remote operation terminal information acquisition device 32 transmits to the server 23 operation information for remote operation of the vehicle 12 that has been input to the operation interface 24.

The display device 34 is a display (see FIG. 2) that displays information received from the server 23. Specifically, the display device 34 can display video footage of areas that the vehicle 12 has acquired and information including the driving route to the current location of the user 16. The display device 34 is allocated to the operator OP inside the control center 22.

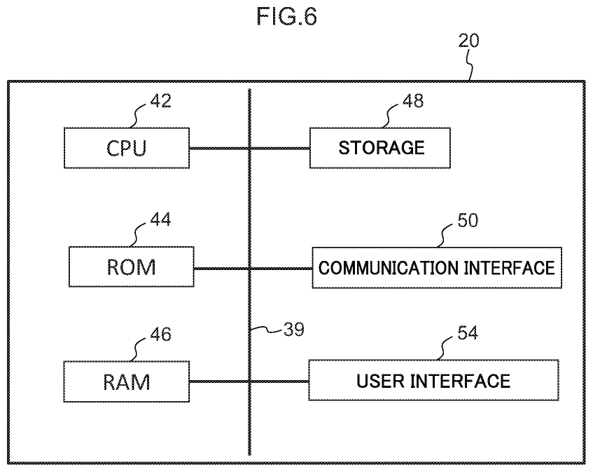

As shown in FIG. 6, the user terminal 20 is configured to include a CPU 42, a ROM 44, a RAM 46, a storage 48, a communication interface 50, and a user interface 54. These configurations are communicably connected to each other via a bus 39. The user interface 54 is an interface when various types of information are displayed and when the user 16 performs input and other operations, and specifically is a liquid crystal display equipped with a touch panel that enables touch operation by the user.

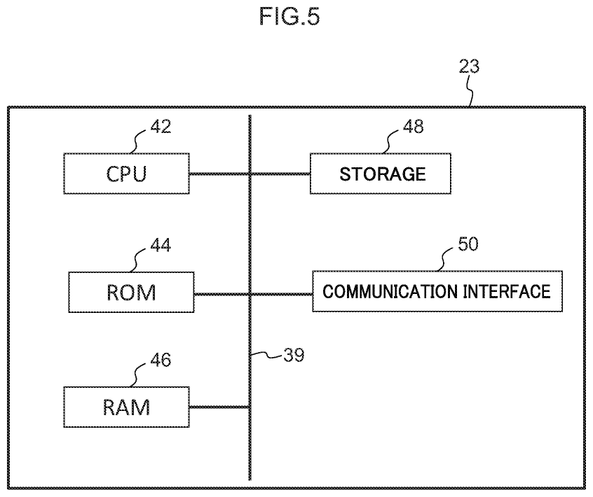

As shown in FIG. 5, the server 23 is configured to include a CPU 42, a ROM 44, a RAM 46, a storage 48, and a communication interface 50. These configurations are communicably connected to each other via a bus 39.

(Functional Configurations)

When executing the above-described vehicle operation program, the vehicle operation system 10 realizes various types of functions using the above-described hardware resources. The functional configurations that the vehicle operation system 10 realizes will now be described.

FIG. 7 is a block diagram showing an example of functional configurations of the vehicle operation system 10.

(Functional Configurations of Vehicle)

As shown in FIG. 7, the vehicle operation system 10 has, as functional configurations of the vehicle 12, an occupant operation information acquisition unit 40, a remote operation information acquisition unit 60, an peripheral information acquisition unit 62, a vehicle control unit 64, a driving mode switching determination unit 67, and a communication unit 68, These functional configurations are realized by the CPU 42 of the on-board unit 14 reading and executing the vehicle operation program stored in the ROM 44 or the storage 48.

The occupant operation information acquisition unit 40 acquires operation information that has been input to the operation interface 28 (see FIG. 3) by an occupant who has gotten into the vehicle 12.

The remote operation information acquisition unit 60 controls the communication unit 68 so as to acquire operation information transmitted from the server 23. The operation information transmitted from the server 23 is the operation information that has been input to the operation interface 24 (see FIG. 4) by the operator OP in the control center 22.

The vehicle control unit 64 controls the driving and steering of the vehicle drive device 36 (see FIG. 2) on the basis of the operation information that has been acquired by the occupant operation information acquisition unit 40 or the remote operation information acquisition unit 60.

The peripheral information acquisition unit 62 acquires the video footage that the imaging device 26 (see FIG. 3) provided in the vehicle 12 has captured as well as various types of information from various types of sensors not shown in the drawings, such as current location information, vehicle model information, driving history including dates and times, total driving distance, remaining amount of fuel, quantities of various types of oil, and tire air pressure, and controls the communication unit 68 so as to transmit these various types of information to the server 23.

The driving mode switching determination unit 67 acquires the state of the driving mode of the vehicle 12. In a case where the vehicle 12 is in a state in which a driving mode switching mechanism not shown in the drawings switches to remote operation, the driving mode switching determination unit 67 controls the communication unit 68 so as to transmit remote operation request information to the server 23. It will be noted that the driving mode switching mechanism can perform not only operations by an occupant who has gotten into the vehicle 12 but also remote operations from the user terminal 20 and the control center 22. Consequently, the user 16 (see FIG. 1) who is outside the vehicle and holding the user terminal 20 can switch the driving mode of the vehicle 12 to remote operation,

The communication unit 68 transmits information to, and receives information from, other devices.

(Functional Configurations of Control Center)

The vehicle operation system 10 has, as functional configurations of the control center 22, a remote operation terminal information acquisition unit 80, a communication unit 82, and a display unit 74. These functional configurations are realized by the CPU 42 of the remote operation terminal information acquisition device 32 reading and executing the vehicle operation program stored in the ROM 44 or the storage 48.

The remote operation terminal information acquisition unit 80 controls the communication unit 82 so as to acquire the operation information from the operation interface 24 (see FIG. 4) that the operator OP (see FIG. 2) performing remote operation operates and transmit the operation information to the server 23.

The display unit 74 controls the display device 34 (see FIG. 4) so as to display to the operator OP the various types of information including the video footage captured by the peripheral information acquisition unit 62 of the vehicle 12 received from the server 23.

The communication unit 82 transmits information to, and receives information from, other devices.

(Functional Configurations of User Terminal)

The vehicle operation system 10 has, as functional configurations of the user terminal 20, an input unit 66, a display unit 74, and a communication unit 78. These configurations are realized by the CPU 42 of the user terminal 20 reading and executing the vehicle operation program stored in the ROM 44 or the storage 48.

The input unit 66 controls the communication unit 78 so as to acquire input information of the user 16 from the user interface 54 (see FIG. 6) and transmit the input information to the server 23. In this embodiment, for example, the position to which, and the date and time at which, the user 16 wants the vehicle 12 to be dispatched can be input.

The display unit 74 controls the user interface 54 (see FIG. 6) so as to display to the user the various types of information acquired by the peripheral information acquisition unit 62 of the vehicle 12 and received from the server 23. In this embodiment, for example, information about the current location of the vehicle 12 being dispatched can be displayed on a map.

The communication unit 78 transmits information to, and. receives information from, other devices.

(Functional Configurations of Server)

The vehicle operation system 10 has, as functional configurations of the server 23, a server control unit 86, an intermediate processing unit 76, a video footage adjustment unit 79, a remote operation control unit 90, a current location identification unit 72, and a communication unit 92. These functional configurations are realized by the CPU 42 of the server 23 reading and executing the vehicle operation program stored in the ROM 44 or the storage 48.

The current location identification unit 72 identifies the current location of the vehicle 12 from the current location information acquired from the peripheral information acquisition unit 62 of the vehicle 12.

The intermediate processing unit 76 generates processed video footage, in which image processing has been performed on the captured video footage acquired from the peripheral information acquisition unit 62 of the vehicle 12 so that it conforms to the display device 34 (see FIG. 4) of the control center 22, and controls the communication unit 92 so as to transmit the processed video footage to the server 23.

The video footage adjustment unit 79 acquires monitoring information about processing conditions in the server 23 and monitoring information about the state of communication on the network N and, on the basis of these various types of information, changes the image quality of the captured video footage and the processed video footage. Specifically, in a case where it has determined that the communication load on the network N from the intermediate processing unit 76 of the server 23 to the display device 34 is high, the video footage adjustment unit 79 transmits a command to the intermediate processing unit 76 to lower the image quality of the processed. video footage below what it is standard. Furthermore, in a case where it has determined that the communication load on the network N from the vehicle 12 to the intermediate processing unit 76 of the server 23 is high, and/or when it has determined that the processing load of the intermediate processing unit 76 itself is high, the video footage adjustment unit 79 transmits a command to the peripheral information acquisition unit 62 via the communication unit 92 to lower the image quality of the captured video footage below what it is standard. It will be noted that when using the intermediate processing unit 76 and the peripheral information acquisition unit 62 to lower the image quality below what it is standard, for example, reversible compression is performed on the video footage. Thus, the data amount of the video footage itself can be reduced.

Here, when the intermediate processing unit 76 has received from the video footage adjustment unit 79 the command to lower the image quality of the processed video footage below the standard image quality, the intermediate processing unit 76 performs image analysis during image processing, and in a case where, as a result of this analysis, there is an object of attention in the captured video footage, the intermediate processing unit 76 applies, during the aforementioned image processing, an attention-getting frame 100 (see FIG. 2) serving as an emphasizing display surrounding the object of attention. The object of attention includes, for example, a pedestrian or a bicycle crossing the road, another vehicle stopped or parked on the road, the user 16 (see FIG. 1) who has requested dispatch of the vehicle 12, and trash and obstacles on the road. In this embodiment, the intermediate processing unit 76 applies the attention-getting frame 100 using as the object of attention the user 16 who requested dispatch of the vehicle 12, and displays the attention-getting frame 100 as processed video footage on the display device 34 (see FIG. 2). It will be noted that when it applies the attention-getting frame 100 to the user 16, for example, the intermediate processing unit 76 performs image analysis from information about the position of the user 16 acquired from the user terminal 20 and preregistered characteristics of the user 16 and identifies the user 16 in the captured video footage.

The remote operation control unit 90 acquires the operation information from the operator OP. Then, when it receives the remote operation request information from the driving mode switching determination unit 67 of the vehicle 12, the remote operation control unit 90 controls the server control unit 86 so as to transmit to the vehicle 12 the operation information it has acquired.

The server control unit 86 controls the server 23. For example, the server control unit 86 acquires various types of information transmitted from the vehicle 12, controls the communication unit 92 so as to transmit that information to the control center 22, and controls the communication unit 92 so as to transmit various types of information from the control center 22 to the vehicle 12.

The communication unit 92 transmits information to, and receives information from, other devices.

(Process Flow)

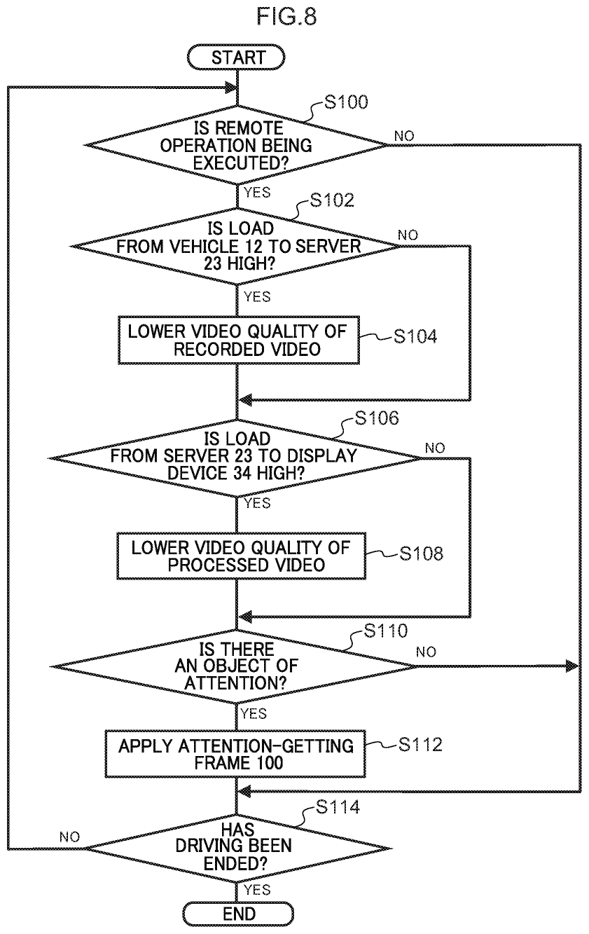

Next, the action of the vehicle operation system 10 will be described. FIG. 8 is a flowchart showing a flow of actions by the vehicle operation system 10. Processes are performed by the CPU 42 of each of the on-board unit 14, the user terminal 20, the remote operation terminal information acquisition device 32, and the server 23 reading the vehicle operation program from the ROM 44 or the storage 48, transferring it to the RAM 46, and executing it.

The CPU 42 determines whether or not the vehicle 12 is in a driving mode in which it is being remotely operated (step S100). In a case where the vehicle 12 is not in a driving mode in which it is being remotely operated (is in a driving mode in which it is being manually driven) (step S100: NO), the CPU 42 moves to the process of step S114 described later. In a case where the vehicle 12 is in a driving mode in which it is remotely operated (step S100: YES), the CPU 42 determines whether the communication load on the network N from the vehicle 12 to the intermediate processing unit 76 of the server 23 is high and/or whether the processing load of the intermediate processing unit 76 itself is high (hereinafter simply called “the load from the vehicle 12 to the server 23 is high”) (step S102). In a case where the load from the vehicle 12 to the server 23 is not high (step S102: NO), the CPU 42 moves to the process of step S106 described later. In a case where the load from the vehicle 12 to the server 23 is high (step S102: YES), the CPU 42 lowers the image quality of the captured video footage below what it is standard (step S104).

The CPU 42 determines whether or not the communication load on the network N from the intermediate processing unit 76 of the server 23 to the display device 34 is high (hereinafter simply called “the load from the server 23 to the display device 34 is high”) (step S106). In a case where the load from the server 23 to the display device 34 is not high (step S106: NO), the CPU 42 moves to the process of step S110 described later. In a case where the load from the server 23 to the display device 34 is high (step S106: YES), the CPU 42 lowers the image quality of the processed video footage below what it is standard (step S108).

The CPU 42 determines whether or not there is an object of attention in the captured video footage (step S110). In a case where there is not an object of attention in the captured video footage (step S110: NO), the CPU 42 moves to the process of step S114 described later. In a case where there is an object of attention in the captured video footage (step S110: YES), the CPU 42 applies, during image processing, the attention-getting frame 100 surrounding the object of attention (see FIG. 2) to thereby generate the processed video footage (step S112).

The CPU 42 determines whether or not the driving of the vehicle 12 has been ended by, for example, the vehicle 12 having arrived at its destination and/or a power unit switch of the vehicle 12 having been switched off (step S114). In a case where the driving of the vehicle 12 has not been ended (step S114: NO), the CPU 42 returns to the process of step S100. In a case where the driving of the vehicle 12 has been ended (step S114: YES), the CPU 42 ends the processes based on the vehicle operation program.

(Action and Effects)

Next, the action and effects of this embodiment will be described.

In this embodiment, as shown in FIG. 7, the vehicle operation system 10 has the peripheral information acquisition unit 62, the remote operation control unit 90, the intermediate processing unit 76, the display unit 74, and the video footage adjustment unit 79. The peripheral information acquisition unit 62 captures video footage of conditions peripheral to the vehicle 12. The remote operation control unit 90 allows the vehicle 12 to be driven by remote operation of the operator OP. The intermediate processing unit 76 acquires captured video footage that the peripheral information acquisition unit 62 has recorded and performs image processing on the captured video footage to thereby generate processed video footage. The display unit 74 displays to the operator OP the processed video footage it has acquired from the intermediate processing unit 76. The video footage adjustment unit 79 changes, in accordance with conditions, the image quality of the captured video footage and the processed video footage. Consequently, by changing the image quality in accordance with the state of communication and the state of image processing, delays when displaying the video footage can be inhibited so that a reduction in operability during remote operation can be inhibited. Because of this, the vehicle operation system 10 can smoothly perform remote operation of the vehicle 12.

Furthermore, even in a case where the processing load of the intermediate processing unit 76 has become high and/or a case where the load on the network N when transmitting the captured video footage from the peripheral information acquisition unit 62 to the intermediate processing unit 76 has become high, a delay in processing can be inhibited because the data amount of the captured video footage is reduced by lowering the image quality below what it is standard. Because of this, the vehicle operation system 10 can smoothly perform remote operation of the vehicle 12 in a case where the load on the network N from the vehicle 12 to the server 23 is high and/or a case where the processing load of the server 23 itself is high.

Moreover, the video footage adjustment unit 79 sets the image quality of the processed video footage lower than the standard image quality, so even in a case where the load on the network N when transmitting the processed video footage from the intermediate processing unit 76 to the display unit 74 has become high, a delay when displaying the processed video footage to the operator OP can be inhibited because the data amount of the processed video footage is reduced by lowering the image quality below what it is standard. Because of this, the vehicle operation system can smoothly perform remote operation of the vehicle in a case where the load on the communication network from the server to the operator is high.

Furthermore, the intermediate processing unit 76 applies the attention-getting frame 100 emphasizing the user 16 in the captured video footage to thereby generate the processed video footage, so it becomes easier for the operator OP to grasp the user 16 even in state in which the image quality of the processed video footage has been reduced below the standard image quality. Because of this, the vehicle operation system 10 can perform remote operation of the vehicle 12 safely and smoothly even in a case where the image quality of the processed video footage is low.

It will be noted that although in this embodiment the attention-getting frame 100 is a frame-like display surrounding the object of attention such as the user 16, it is not limited to this and may also be, for example, an arrow display pointing to the object of attention or another display.

Furthermore, the attention-getting frame 100 is displayed so as to surround the user 16 who requested dispatch of the vehicle 12, but it is not limited to this. For example, in a case where the user 16 cannot be found, the intermediate processing unit 76 or the like may determine an appropriate parking or stopping position for the vehicle and present the position by means of the attention-getting frame 100 to the operator OP.

Moreover, to prevent a user different from the user 16 who requested dispatch from getting into the vehicle 12, a one-time key may be allocated to the user terminal 20, and the vehicle control unit 64 may be set to unlock the doors of the vehicle 12 in a case where a key that the user 16 has input matches the one-time key.

An embodiment of the disclosure has been described above, but the disclosure is not limited to what is described above and can of course be modified and implemented in a variety of ways, in addition to what is described above, in a range that does not depart from the spirit thereof.

What is claimed is:

1. A vehicle operation system, comprising:
an imaging device configured to capture video footage of conditions peripheral to a vehicle;
a display device;
a memory; and
a processor that is coupled to the memory, the processor being configured to:
allow the vehicle to be driven by remote operation by an operator;
acquire video footage captured by the imaging device and perform image processing on the captured video footage to thereby generate processed video footage;
display the processed video footage to the operator at the display device; and
change image qualities of the captured video footage and the processed video footage in accordance with predetermined status information.

2. The vehicle operation system according to claim 1, wherein the processor is configured to set an image quality of the captured video footage to be lower than a standard image quality.

3. The vehicle operation system according to claim 1, wherein the processor is configured to set an image quality of the processed video footage to be lower than a standard image quality.

4. The vehicle operation system according to claim 3, wherein the processor generates the processed video footage by applying an emphasis display that emphasizes an object of attention in the captured video footage.

5. The vehicle operation system according to claim 1, wherein the processor acquires monitoring information regarding processing conditions at the processor and monitoring information regarding a state of communication from the imaging device to the processor when the processor acquires the video footage captured by the imaging device, and, from the monitoring information, in a case corresponding to at least one of a case in which a processing load of the processor itself is high or a case in which a communication load of the state of communication is high, sets an image quality of the captured video footage to be lower than a standard image quality.

6. The vehicle operation system according to claim 1, wherein the processor acquires monitoring information regarding a state of communication from the processor to the display device when the display device acquires the processed video footage from the processor, and, from the monitoring information, in a case in which a communication load of the state of communication is high, sets an image quality of the processed video footage to be lower than a standard image quality.

7. The vehicle operation system according to claim 4, wherein the processor performs image analysis based on information regarding a position of a user acquired from a user terminal carried by the user and based on preregistered characteristics of the user, identifies the user in the captured video footage, and applies the emphasis display to the user.

8. The vehicle operation system according to claim 4, wherein the processor determines an appropriate parking or stopping position for the vehicle and applies the emphasis display to the appropriate parking or stopping position.
